(19) United States
(12) Patent Application Publication
(10) Pub. No.: US 2026/0012286 A1
(43) Pub. Date: Jan. 8, 2026

(54) PHYSICAL LAYER DEVICE PROVIDING CONSTANT LATENCY NIBBLE TRANSPORT WHEN USING BYTE-BASED ENCODING

(71) Applicant: Axonne, Inc., Sunnyvale, CA (US)

(72) Inventor: William LO, Cupertino, CA (US)

(21) Appl. No.: 19/261,435

(22) Filed: Jul. 7, 2025

Related U.S. Application Data
(60) Provisional application No. 63/668,562, filed on Jul. 8, 2024.

(51) Int. Cl. H04L 1/00

(52) U.S. Cl. CPC H04L 1/0042

(57) ABSTRACT

A physical layer device includes a nibble combining module configured to receive a plurality of types of packets, wherein the plurality of types of packets include an even or odd number of nibbles and an even or odd starting boundary. The nibble combining module is configured to combine the nibbles of the plurality of types of packets into a plurality of bytes. An encoding module is configured to encode the plurality of bytes of the packet. A transmitter is configured to transmit the encoded plurality of bytes. Latency of the nibble combining module for the plurality of types of packets is the same.

### CROSS-REFERENCE TO RELATED APPLICATIONS

This application claims the benefit of U.S. Provisional Application No. 63/668,562, which was filed on Jul. 8, 2024. The entire disclosure of the application referenced above is incorporated herein by reference.

### FIELD

The present disclosure relates to physical layer devices for communication channels, and more particularly to a physical layer device for a communication channel with constant latency nibble transport over byte-based encoding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Ethernet frames are byte based where the smallest unit of transported data is 1byte. All of the preambles and inter packet gaps (IPGs) from a medium access control (MAC) device are also assumed to be in units of 1 byte. Depending upon the underlying medium used, it may be possible to see non-integer number of bytes in the preambles and IPGs as the packets traverse through the network.

For low speed Ethernet of 10 Mb/s and 100 Mb/s, the data can be passed between the MAC and PHY via a MII (Media independent interface) as defined in IEEE 802.3. The MII is nibble based 4-bits). In a properly behaving MAC, the MAC should always output an even number of nibbles of packets and an even number of nibbles for IPGs. A well-formed Ethernet packet includes 8 bytes of preamble with hex values 55 55 55 55 55 55 55 D5 followed by some number of bytes of data.

### SUMMARY

A physical layer device includes a nibble combining module configured to receive a plurality of types of packets, wherein the plurality of types of packets include an even or odd number of nibbles and an even or odd starting boundary. The nibble combining module is configured to combine the nibbles of the plurality of types of packets into a plurality of bytes. An encoding module is configured to encode the plurality of bytes of the packet. A transmitter is configured to transmit the encoded plurality of bytes. Latency of the nibble combining module for the plurality of types of packets is the same.

In other features, the plurality of types of packets include a first type of packet including an even number of nibbles starting at an even boundary, a second type of packet including an even number of nibbles starting at an odd boundary, a third type of packet including an odd number of nibbles starting at an even boundary, and a fourth type of packet including an odd number of nibbles starting at an odd boundary.

In other features, one of the first type of packet and the second type of packet is received, the nibble combining module is configured to combine even nibbles and odd nibbles into bytes. When one of the third type of packet and the fourth type of packet is received, the nibble combining module is configured to group first, second, and third nibbles of the second type of packet into a first control symbol. The nibble combining module is configured to group pairs of remaining odd nibbles and even nibbles of the one of the third type of packet and the fourth type of packet into bytes.

In other features, the first, second, and third nibbles correspond to idle, data, and data, respectively. If last nibbles of one of the first, second, third or fourth type of packets include data and idle, the nibble combining module is configured to group the data and idle to a second code symbol. At an end of the one of the third type of packet and the fourth type of packet, the nibble combining module is configured to convert a single idle nibble to an idle symbol.

In other features, when the nibble combining module is configured to group a pair of adjacent nibbles into an output byte, a first nibble is data, and a second nibble is data, the output byte from the nibble combining module includes {the data from the second nibble, the data from the first nibble}. When the nibble combining module is configured to group pairs of adjacent nibbles into a byte and a first one of the pairs of adjacent nibbles and a second one of the pairs of adjacent nibbles are equal to the same control code, the byte output by the nibble combining module includes an equivalent control symbol.

In other features, the control code is selected from a group consisting of idle, lower power idle, sequence, and error. When the nibble combining module groups pairs of adjacent nibbles into a byte and at least one of a first one of the pairs of adjacent nibbles and a second one of the pairs of adjacent nibbles is an error code, the byte output by the nibble combining module includes an error symbol.

In other features, when the nibble combining module groups pairs of adjacent nibbles into a byte and a first one of the pairs of adjacent nibbles and a second one of the pairs of adjacent nibbles are different control codes, the byte output by the nibble combining module includes an equivalent control symbol corresponding to the control code of the first nibble.

In other features, when the nibble combining module groups pairs of adjacent nibbles into a byte and a first one of the pairs of adjacent nibbles is data and a second one of the pairs of adjacent nibbles is idle, the byte output by the nibble combining module includes a third control symbol.

In other features, a receiver is configured to receive an encoded packet. A decoding module configured to decode the encoded packet into a decoded packet. A byte splitting module is configured to split bytes of the decoded packet into nibbles.

In other features, when the receiver receives a byte including a first control symbol, the splitting module is configured to output first, second and third nibbles. The first, second and third nibbles include idle, 0x5, and 0x5, respectively.

In other features, when the receiver receives a byte including a second control symbol, the splitting module is configured to output first, second, and third nibbles including idle, O, and O, respectively, where O is an ordered set nibble. When the receiver receives a byte including a third control symbol, the splitting module of the receiver is configured to output first and second nibbles including data and idle, respectively. When a first idle after an end of a packet that started with one of a first control symbol and a second control symbol is received, the splitting module is configured to output a first nibble including idle. When a first idle after an end of a packet that did not start with a control symbol is received, the splitting module is configured to output first and second nibbles including idle and idle, respectively. When an output of the decoding module is data, the splitting module is configured to output first and second nibbles including data and data, respectively. When an output of the decoding module is control, the splitting module is configured to output a first nibble and a second nibble including control and control, respectively.

In other features, the encoding module performs 8N/(8N+1) encoding, where N is equal to the number of bytes. The encoding module embeds a control byte including a 5-bit pointer and a 3-bit control word. Bits 0 to 2 of the control byte point to a next control symbol that is a control word. Bits 3 and 4 of the control byte indicate whether there are any more control symbols after the next control symbol.

In other features, if bits 3:4 of the control byte are 00, there are no more control symbols after the next control symbol. If bit 3 of the control byte is 0, bits 5 to 7 specify control codes. If bit 3 of the control byte is 1, then bits 4 to 7 include a dribble nibble followed by idle.

In other features, when the 3-bit control word indicates a sequence, the 3-bit control word corresponds to first and second nibbles including ordered sets. When the 3-bit control word indicates transmit error propagation, the 3-bit control word corresponds to first and second nibbles including error codes. When the 3-bit control word indicates normal inter-frame, the 3-bit control word corresponds to first, second, and third nibbles including idles. When the 3-bit control word indicates start of frame with leading idle, the 3-bit control word corresponds to first, second, and third nibbles include idle, 0x5, and 0x5. When the 3-bit control word indicates sequence with leading idle, the 3-bit control word corresponds to first, second, and third nibbles include idle, ordered set, and ordered set. When the 3-bit control word indicates assert low power idle, the 3-bit control word corresponds to first and second nibbles including low power idles.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of a communication channel including host

devices including or connected to interfaces that communicate over a line according to the present disclosure;

FIG. 2 is a functional block diagram of an example of physical layer devices of the interfaces of FIG. 1 according to the present disclosure;

FIG. 3 illustrates an example of transmit nibbles converted into a block by an encoding module and recovery of the nibbles by a receiver according to the present disclosure;

FIGS. 4 to 6 illustrate examples of variations in latency from the encoding module input to the receiver in different scenarios;

FIGS. 7 to 10 illustrate examples of fixed latency from the encoding module input to the receiver in different scenarios according to the present disclosure;

FIG. 11 is a table illustrating examples of actions in various scenarios according to the present disclosure;

FIG. 12 is a table illustrating examples of actions in various scenarios when grouping 2 nibbles into a byte according to the present disclosure;

FIG. 13 is a table illustrating examples of usage of control codes according to the present disclosure; and

FIGS. 14 and 15 are tables illustrating examples of mapping of the method described above onto an 8N/(8N+1) coding according to the present disclosure.

In the drawings, reference numbers may be reused to identify similar and/or identical elements.

### DESCRIPTION

As will be described further below, the present disclosure relates to a physical layer device of an interface that provides constant latency nibble transport when using byte-based encoding.

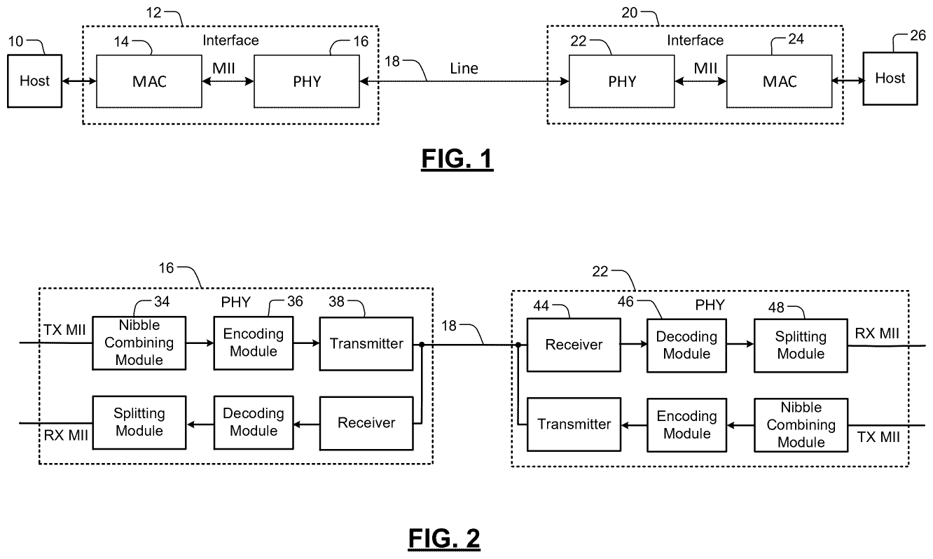

FIG. 1 shows a communication channel including a host device 10 connected to an interface 12 including a media access control (MAC) device 14 and a physical layer (PHY) device 16. The interface 12 is connected by a line 18 to another interface 20. The interface 20 includes a MAC device 24 and a PHY 22. The interface 20 is associated with a host device 26. Communication over the line 18 is bidirectional.

Ethernet frames are byte-based with a smallest unit of transported data of 1 byte. Preambles and inter packet gaps (IPGs) from the MAC devices 14 or 24 are also assumed to be in units of 1 byte. Depending on the underlying medium that is used, it may be possible to see non-integer numbers of bytes in the preambles and IPGs as the packet traverses through the network.

For low speed Ethernet of 10 Mb/s and 100 Mb/s, the data can be passed between the MAC and PHY via a media independent interface (MII) as defined in IEEE 802.3. The MII is nibble based (4-bits). In a properly behaving MAC, the MAC should always output an even number of nibbles of packets and an even number of nibbles for IPGs. A well-formed Ethernet packet includes 8 bytes of preamble with hex values 55 55 55 55 55 55 55 D5 followed by some number of bytes of data.

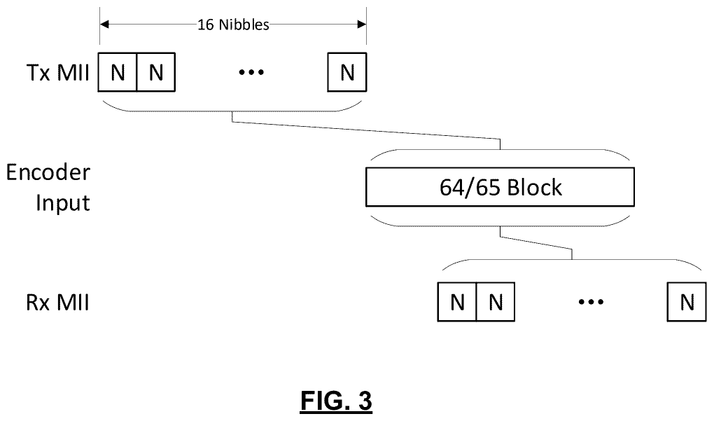

FIG. 2 shows transmission of data from the PHY 16 to the PHY 22 in further detail. In the transmit direction, the PHY 16 includes a nibble combining module 34 configured to combine pairs of nibbles into bytes. The PHY 16 includes an encoding module 36 configured to encode a group of two or more bytes. The PHY 16 include a transmitter 38 to output the encoded data on the line 18.

On the receiver side, the PHY 22 includes a receiver 44 configured to receive encoded packet data (e.g., the encoded bytes after transmission on the line 18). The PHY 22 includes a decoding module 46 configured to decode the encoded packet data. The PHY 22 includes a splitting module 48 configured to split the bytes of the decoded packet data into nibbles. The PHY 16 and the PHY 22 are bidirectional and include transmit and receive paths in the opposite directions as shown.

When fitting nibbles into a byte-based encoding system, two nibbles are typically combined by the nibble combining module 34 to form a byte. The first nibble is called an even (E) nibble and the second nibble is called an odd (O) nibble. Some byte-based encoding schemes are 8-bit/10-bit encoding used in a serial gigabit media independent interface (SGMII), or an 8N/(8N+1) as described in U.S. Pat. No. 9,749,237, which is hereby incorporated herein by reference in its entirety. The nibbles are combined into some number of bytes and then encoded by the encoding module 36. For example, in the 8-bit/10-bit, two nibbles are combined to form 1 byte and are then presented to the encoding module 36. Similarly, for 8N/(8N+1) (where N=8), 16 nibbles form 8 bytes, and the 8 bytes (64 bits) are passed to the encoding module 36.

In a perfectly aligned system, the number of nibbles in a packet is even and the first nibble of the packet (the even nibble) on a media independent interface (MII) starts at the even boundary relative to the byte. To compensate for frequency drift in the network, some devices may insert or delete nibbles of idles. The minimum number of bytes of IPG is nominally 12 bytes though this can be less with deletion of idle nibbles.

There are many legacy 10 Mb/s and 100 Mb/s systems in the field that may send an odd number of nibbles in packets and/or an odd number of nibbles in preambles. There are also systems that may compensate for an odd number of nibbles in the preamble to pad the end of data with a dummy data nibble. There is also a 50% chance that the even/odd nibbles on the MAC side of the MII is aligned to the even/odd boundary of the PHY side of the MII.

In these systems, the nibbles may no longer be aligned. It is possible to receive an even number of nibbles in the packet starting at the even boundary; an even number of nibbles in the packet starting at the odd boundary; an odd number of nibbles in the packet starting at the even boundary; or an odd number of nibbles in the packet starting at the odd boundary. As discussed below, the alignment issue results in variability on the latency in a system.

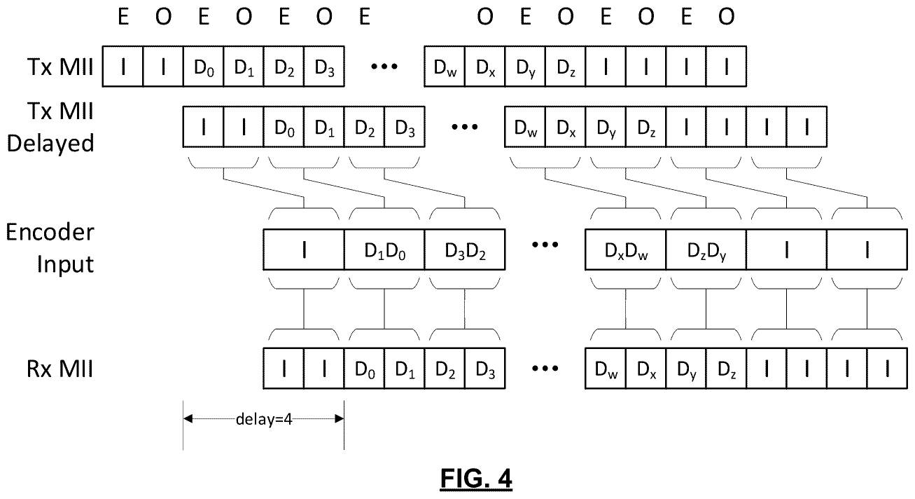

The latency from the transmit (TX) MII to receive (RX) MII includes a period to accumulate a sufficient number of nibbles to form bytes to present to the encoding module followed by the rest of the delays in the system. In FIG. 3, 16 nibbles are accumulated to form 8 bytes (64 bits). The encoding module encodes the 64 bits to 65 bits. The data passes through the rest of the transmit and receive paths and is finally output to the RX MII. Note that some delay from the encoding module input to the RX MII is shown. To make the diagrams more readable, the delay from the encoding module input to the RX MII is a fixed constant in all scenarios but is shown with zero delay. The important thing to note is the relative delays between various scenarios and not the absolute delays.

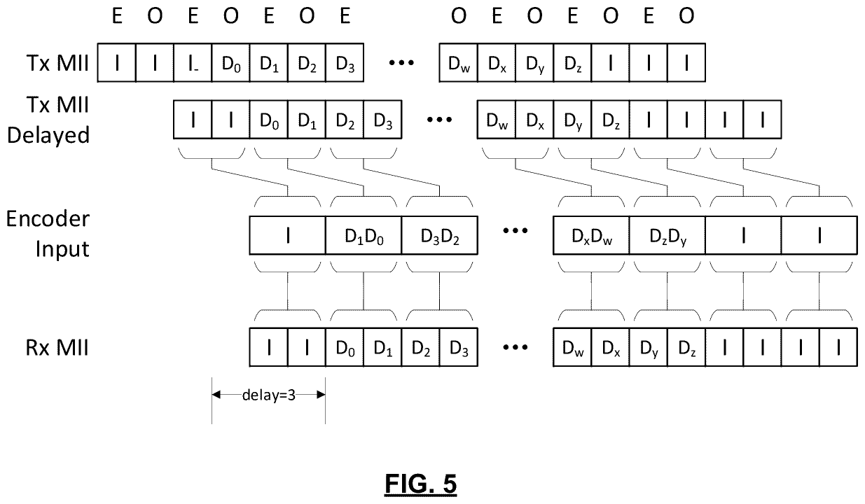

In FIG. 4, there is zero delay shown from the encoding module input to the RX MII. The E and O represent the even and odd nibbles relative to the encoding modules. The I represents an idle nibble, and D represents a data nibble. Note that D₀ and D₁ are always preamble nibbles and always 0x5 and 0x5, respectively. In this particular example, the data is aligned correctly with the start of packet presented at the even nibble.

The TX MII is delayed two nibble times, and the nibbles are combined into bytes after two nibble times later. The relative delay is 4 nibble times from the TX MII to RX MII. The choice of 4 nibble time delay is arbitrary but is sufficient for designing a causal system in the example below where the packet starts on an odd nibble boundary.

FIG. 5 shows a situation where the start of packet occurs on an odd nibble. One common method to compensate for the alignment mismatch is to throw away one idle nibble (shown as I.). Here, the relative delay is 3 nibble times. If the next packet starts on the odd nibble, this 3 nibble time delay persists. If the next packet starts on the even nibble, an idle can be inserted and the condition will be like the condition above with a relative delay of 4 nibble times.

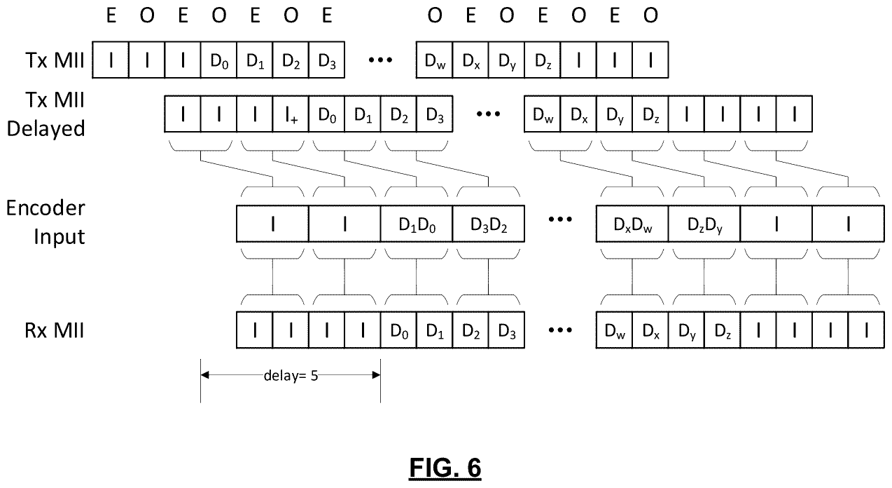

FIG. 6 shows an alternate approach if the start of packet occurs on an odd nibble. The alignment mismatch can be compensated by adding one idle nibble (shown as 1+). Here, the relative delay is 5 nibble times. If the next packet starts on the odd nibble, this 5 nibble time delay persists. If the next packet starts on the even nibble, an idle can be deleted and the condition will be like the condition two diagrams above with a relative delay of 4 nibble times.

Time synchronization is usually performed in the MAC by observing when packets appear on the TX MII and RX MII. Ideally the latency from TX MII and RX MII should be constant. As shown above, depending on when a packet starts, the latency can vary by a nibble time. For 100 Mb/s systems, one nibble time is 40 ns and for 10 Mb/s systems, one nibble time is 400 ns. This inaccuracy is quite large when trying to achieve sub 10 ns accuracy. The scheme above also does not address the issue when there is an odd number of nibbles in the packet. If the system pads up a nibble or truncates the final nibble, the receiver does not know if the final byte contains a pad nibble. Byte-based encoding modules are commonly used in PHYs. Therefore, it would be useful to carry nibble-based data using a byte-based encoding module without introducing latency variation.

The present disclosure shows how the four types described above are handled to achieve constant latency from TX MII to RX MII, and to handle odd nibbles in packets. In all four types, the relative delay from TX MII to RX MII is equal to two nibble times. An example of how this can be implemented is given for 8N/(8N+1) encoding.

### Achieving Constant Latency

### Type 1: Even Number of Nibbles in the Packet Starting at Even Boundary

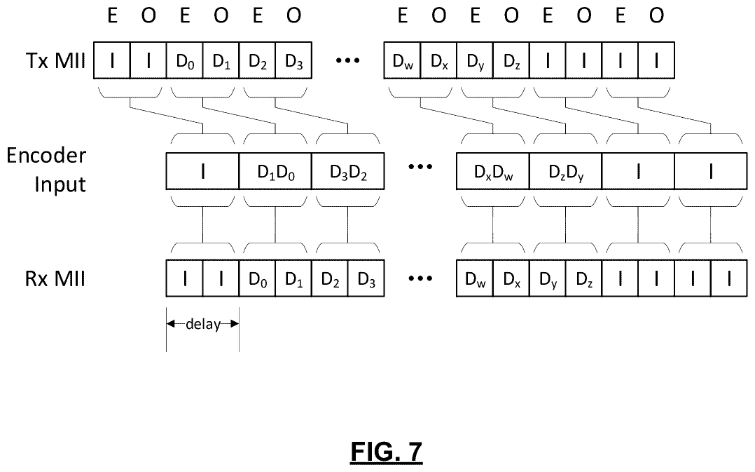

In FIG. 7, a first type of packet includes an even number of nibbles starting at the even boundary. Two nibbles are combined to form a byte and the bytes are presented to the encoding module with a two nibble time delay. Note that there may be additional delays between the TX MII and the input of the decode. The delays are constant for all types and are shown as zero delay here to make the diagrams easier to understand.

### Type 2: Even Number of Nibbles in the Packet Starting at Odd Boundary

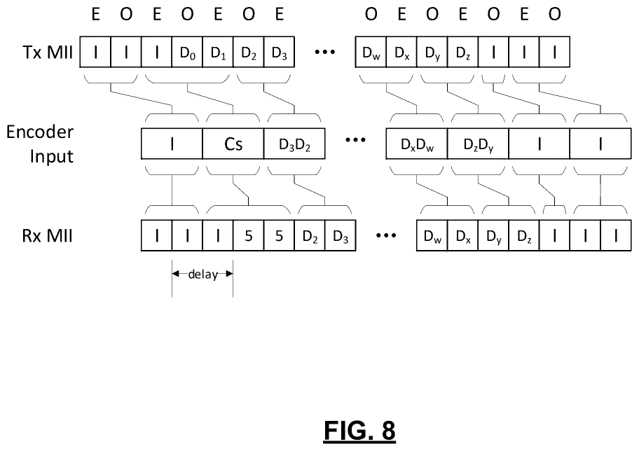

In FIG. 8, a second type of packet includes an even number of nibbles starting at the odd boundary. An idle nibble preceding the packet and the first two nibbles of the packet (always 0x5 0x5) are represented as a control symbol Cs. All subsequent nibbles are combined into bytes but are presented with one nibble time delay. The first idle after the end of packet is expanded as one byte of idle to the encoding module.

At the output of the decoding module, the Cs control symbol is output as three nibbles: idle, 0x5, 0x5. The first idle byte seen after the end of packet is only converted to 1 idle nibble.

### Type 3: Odd Number of Nibbles in the Packet Starting at Even Boundary

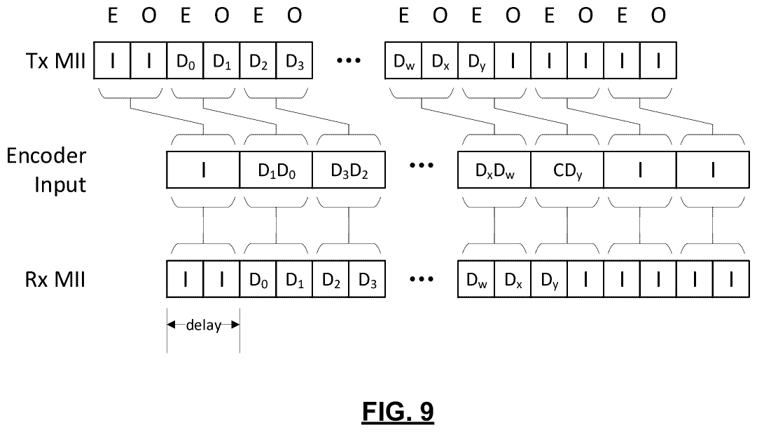

In FIG. 9, a third type of packet includes an odd number of nibbles starting at even boundary. This type is similar to Type 1 except for a final nibble. The final nibble (and optionally an idle nibble) are output as one of y control codes (CD_{y}) (e.g., y=0 to 15) with each control code representing one possible value of the final nibble. At the output of the decoding module, the control code CD_{y} is converted back to the data nibble and the idle nibble.

### Type 4: Odd Number of Nibbles in the Packet Starting at Odd Boundary

In FIG. 10, a fourth type of packet includes an odd number of nibbles starting at odd boundary. This type is similar to Type 2 at the start of packet and similar to Type 3 at the end of packet. The second idle after the end of packet is expanded as one byte of idle to the encoding module. The output of the decoding module behaves similarly to Type 2 and Type 3.

### Ordered Set Handling.

Ordered set is in the form an 8 nibble sequence such as O, O, D, D, D, D, D, D where O is the ordered set nibble and D is data. Typically ordered sets are sent back to back without any idles in between, and are separated by idles.

A sequence of ordered sets can be treated as one big non-stop packet between idles. If ordered set sequence starts on the even nibble, the situation is handled similar to type 1. If ordered set sequence starts on the odd nibble, then it is similar to type 2 except a Co symbol is used instead of Cs.

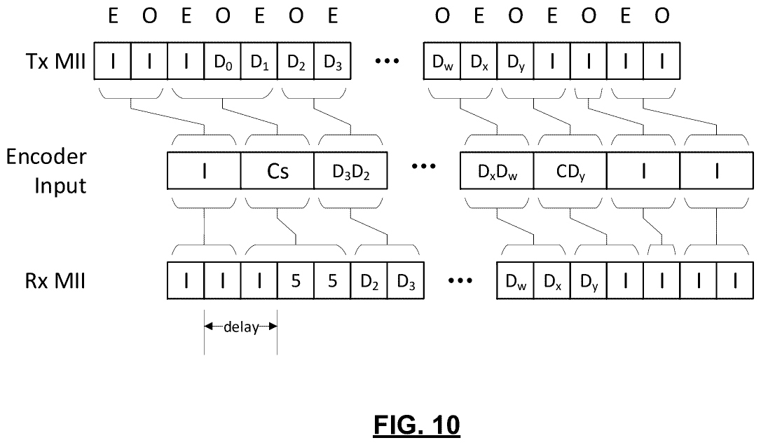

Referring now to FIG. 11, a summary of actions is shown. When the packet starts at the even nibble, the nibble combining module combines the even nibble and the odd nibble. When the start of the packet is at an odd nibble, the nibble combining module groups the first 3 nibbles (idle, data, data) to a Cs symbol and groups an odd nibble and even nibble to a byte. If the end of a packet is a data and idle, the nibble combining module groups the data and idle to one of 16 CD symbols. At the end of a packet that started on an odd nibble, a single idle nibble is converted to an idle symbol.

In FIG. 12, actions when grouping 2 nibbles into a byte are shown. If a first nibble is data1 and a second nibble is data2, then the byte includes {data2, data1}. If a first nibble is control and a second is control (and both are the same), the byte that is output includes an equivalent control symbol. Examples of control symbols include idle, lower power idle, sequence, or error. If either of the nibbles are error, the byte includes an error symbol. If a first nibble is control1 and a second is control2 (e.g., different) and control2 is not an error symbol, then the byte includes an equivalent control symbol corresponding to control1. If a first nibble is data and a second nibble is an idle, then the byte includes one of the 16 CD symbols. The control1, control2 type described above does not normally happen except in rare types when the MAC enters and exits low power idle without being byte-aligned.

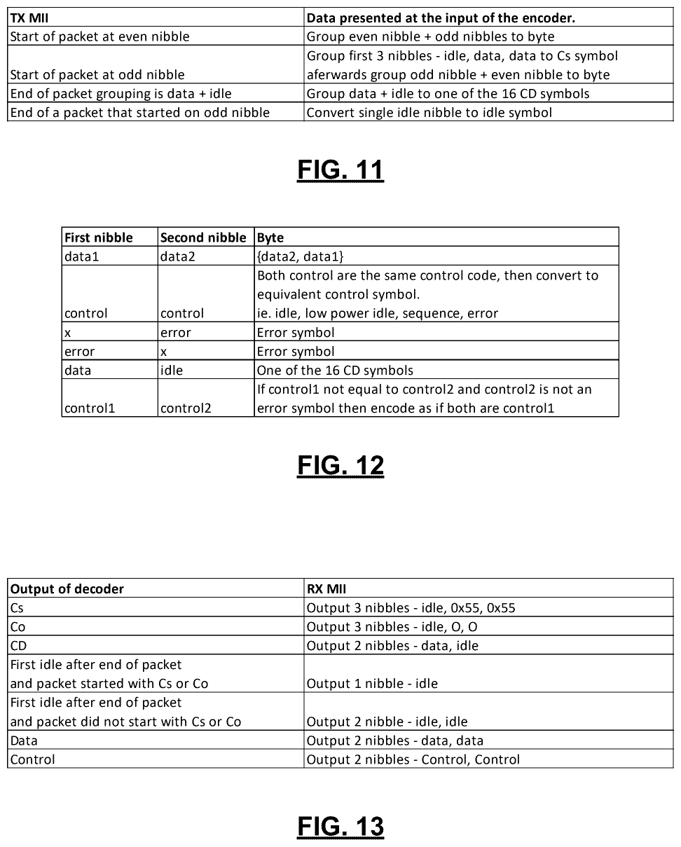

In FIG. 13, when the receiver receives the control symbol Cs, the splitting module of the receiver outputs 3 nibbles including idle, 0x5, and 0x5. When the receiver receives the control symbol Co, the splitting module of the receiver outputs 3 nibbles including idle, O, and O, respectively (where O is an ordered set nibble). When the receiver receives the control symbol CD, the splitting module of the receiver outputs 2 nibbles including data, idle.

At the first idle after the end of packet (that started with the control symbol Cs or Co), the splitting module of the receiver outputs 1 nibble including idle. At the first idle after the end of packet (that did not start with the control symbol Cs or Co), the splitting module of the receiver outputs 2 nibbles including idle, idle.

If the output of the decoding module is data, the splitting module of the receiver outputs 2 nibbles including data, data. If the output of the decoding module is control, the splitting module of the receiver outputs 2 nibbles including control, control.

### 8N/(8N+1) Enhancement

U.S. Pat. No. 9,749,237 teaches the use of a 5-bit pointer (bits 0 to 4) and a 3-bit control word (bits 5 to 7). Bits 0 to 3 point to the next symbol that is a control word and allows N up to 16. Bit 4 indicates whether there are any more control symbols after the next control symbol.

The enhancement here to implement section 2.1 is to repurpose one bit of the pointer. Bits 0 to 2 point to the next symbol that is a control word and allows N up to 8. Bit 3:4 indicates whether there are any more control symbols after the next control symbol. 00 indicates no more control symbols otherwise there is more.

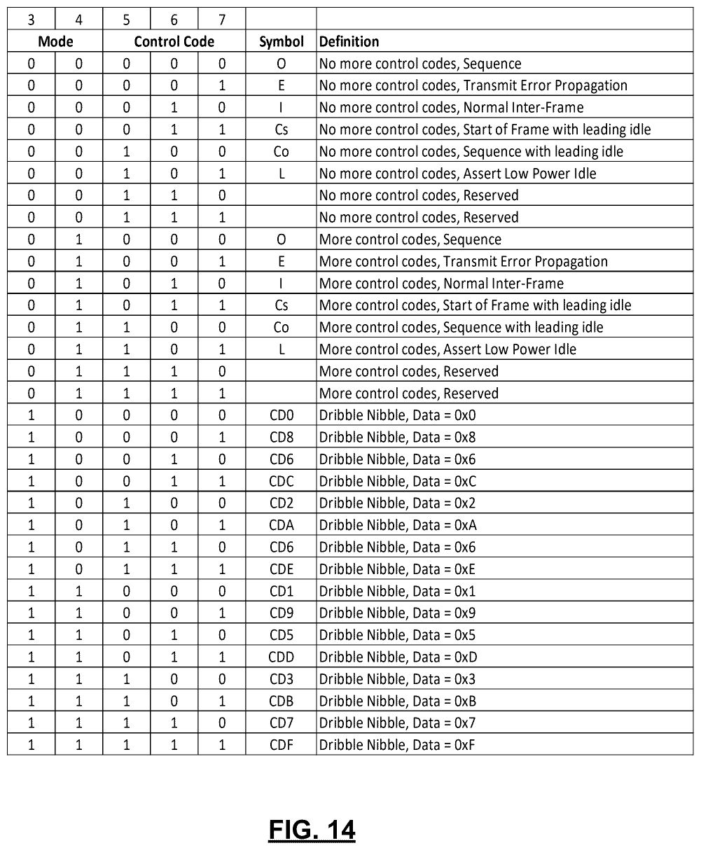

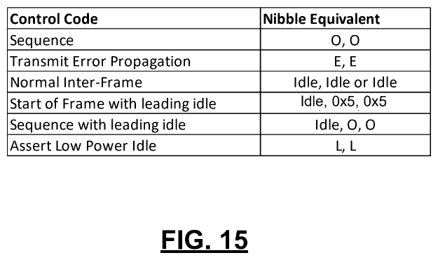

If bit 3=0, it indicates bits 5 to 7 are regular control words. If bit 3=1, then bits 4 to 7 is a dribble nibble followed by idle. Note that more control symbols is implicit after a dribble nibble since idle control word is expected immediately after this symbol. In the tables in FIGS. 14 and 15, an example on how this can be mapped onto the 8N/(8N+1) coding is shown.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A physical layer device comprising:
a nibble combining module configured to receive a plurality of types of packets, wherein the plurality of types of packets include an even or odd number of nibbles and an even or odd starting boundary,
wherein the nibble combining module is configured to combine the nibbles of the plurality of types of packets into a plurality of bytes;
an encoding module configured to encode the plurality of bytes of the packet; and
a transmitter configured to transmit the encoded plurality of bytes,
wherein latency of the nibble combining module for the plurality of types of packets is the same.

2. The physical layer device of claim 1, wherein the plurality of types of packets include:
a first type of packet including an even number of nibbles starting at an even boundary;
a second type of packet including an even number of nibbles starting at an odd boundary;
a third type of packet including an odd number of nibbles starting at an even boundary; and
a fourth type of packet including an odd number of nibbles starting at an odd boundary.

3. The physical layer device of claim 2, wherein, when one of the first type of packet and the second type of packet is received, the nibble combining module is configured to combine even nibbles and odd nibbles into bytes.

4. The physical layer device of claim 2, wherein, when one of the third type of packet and the fourth type of packet is received, the nibble combining module is configured to group first, second, and third nibbles of the second type of packet into a first control symbol.

5. The physical layer device of claim 4, wherein the nibble combining module is configured to group pairs of remaining odd nibbles and even nibbles of the one of the third type of packet and the fourth type of packet into bytes.

6. The physical layer device of claim 4, wherein the first, second, and third nibbles correspond to idle, data, and data, respectively.

7. The physical layer device of claim 4, wherein, if last nibbles of one of the first, second, third or fourth type of packets include data and idle, the nibble combining module is configured to group the data and idle to a second code symbol.

8. The physical layer device of claim 4, wherein, at an end of the one of the third type of packet and the fourth type of packet, the nibble combining module is configured to convert a single idle nibble to an idle symbol.

9. The physical layer device of claim 1, wherein, when the nibble combining module is configured to group a pair of adjacent nibbles into an output byte, a first nibble is data, and a second nibble is data, the output byte from the nibble combining module includes {the data from the second nibble, the data from the first nibble}.

10. The physical layer device of claim 1, wherein, when the nibble combining module is configured to group pairs of adjacent nibbles into a byte and a first one of the pairs of adjacent nibbles and a second one of the pairs of adjacent nibbles are equal to the same control code, the byte output by the nibble combining module includes an equivalent control symbol.

11. The physical layer device of claim 10, wherein the control code is selected from a group consisting of idle, lower power idle, sequence, and error.

12. The physical layer device of claim 1, wherein, when the nibble combining module groups pairs of adjacent nibbles into a byte and at least one of a first one of the pairs of adjacent nibbles and a second one of the pairs of adjacent nibbles is an error code, the byte output by the nibble combining module includes an error symbol.

13. The physical layer device of claim 1, wherein, when the nibble combining module groups pairs of adjacent nibbles into a byte and a first one of the pairs of adjacent nibbles and a second one of the pairs of adjacent nibbles are different control codes, the byte output by the nibble combining module includes an equivalent control symbol corresponding to the control code of the first nibble.

14. The physical layer device of claim 1, wherein, when the nibble combining module groups pairs of adjacent nibbles into a byte and a first one of the pairs of adjacent nibbles is data and a second one of the pairs of adjacent nibbles is idle, the byte output by the nibble combining module includes a third control symbol.

15. The physical layer device of claim 1, further comprising:
a receiver configured to receive an encoded packet;
a decoding module configured to decode the encoded packet into a decoded packet; and
a byte splitting module configured to split bytes of the decoded packet into nibbles.

16. The physical layer device of claim 15, wherein when the receiver receives a byte including a first control symbol, the splitting module is configured to output first, second and third nibbles.

17. The physical layer device of claim 16, wherein the first, second and third nibbles include idle, 0x5, and 0x5, respectively.

18. The physical layer device of claim 15, wherein when the receiver receives a byte including a second control symbol, the splitting module is configured to output first, second, and third nibbles including idle, O, and O, respectively, where O is an ordered set nibble.

19. The physical layer device of claim 15, wherein when the receiver receives a byte including a third control symbol, the splitting module of the receiver is configured to output first and second nibbles including data and idle, respectively.

20. The physical layer device of claim 15, wherein when a first idle after an end of a packet that started with one of a first control symbol and a second control symbol is received, the splitting module is configured to output a first nibble including idle.

21. The physical layer device of claim 15, wherein when a first idle after an end of a packet that did not start with a control symbol is received, the splitting module is configured to output first and second nibbles including idle and idle, respectively.

22. The physical layer device of claim 15, wherein when an output of the decoding module is data, the splitting module is configured to output first and second nibbles including data and data, respectively.

23. The physical layer device of claim 15, wherein when an output of the decoding module is control, the splitting module is configured to output a first nibble and a second nibble including control and control, respectively.

24. The physical layer device of claim 1, wherein the encoding module performs 8N/(8N+1) encoding, where N is equal to the number of bytes.

25. The physical layer device of claim 24, wherein:
the encoding module embeds a control byte including a 5-bit pointer and a 3-bit control word,
bits 0 to 2 of the control byte point to a next control symbol that is a control word, and
bits 3 and 4 of the control byte indicate whether there are any more control symbols after the next control symbol.

26. The physical layer device of claim 25, wherein:
if bits 3:4 of the control byte are 00, there are no more control symbols after the next control symbol; and
if bit 3 of the control byte is 0, bits 5 to 7 specify control codes.

27. The physical layer device of claim 26, wherein if bit 3 of the control byte is 1, then bits 4 to 7 include a dribble nibble followed by idle.

28. The physical layer device of claim 26, wherein when the 3-bit control word indicates a sequence, the 3-bit control word corresponds to first and second nibbles including ordered sets.

29. The physical layer device of claim 26, wherein when the 3-bit control word indicates transmit error propagation, the 3-bit control word corresponds to first and second nibbles including error codes.

30. The physical layer device of claim 26, wherein when the 3-bit control word indicates normal inter-frame, the 3-bit control word corresponds to first, second, and third nibbles including idles.

31. The physical layer device of claim 26, wherein when the 3-bit control word indicates start of frame with leading idle, the 3-bit control word corresponds to first, second, and third nibbles include idle, 0x5, and 0x5.

32. The physical layer device of claim 26, wherein when the 3-bit control word indicates sequence with leading idle, the 3-bit control word corresponds to first, second, and third nibbles include idle, ordered set, and ordered set.

33. The physical layer device of claim 26, wherein when the 3-bit control word indicates assert low power idle, the 3-bit control word corresponds to first and second nibbles including low power idles.
